(19) United States
(12) Patent Application Publication
(10) Pub. No.: US 2003/0061209 A1
(43) Pub. Date: Mar. 27, 2003

(54) Computer user interface tool for navigation of data stored in directed graphs

(76) Inventors: Simon D. Raboczi, Auchenflower (AU); Tate Jones, Kelvin Grove (AU); David P. Hyland-Wood, Chapel Hill (AU)

Correspondence Address: STRAUB & POKOTYLO, 1 BETHANY ROAD, SUITE 83, BUILDING 6, HAZLET, NJ, 07730, US

(21) Appl. No.: 10/134,068

(22) Filed: Apr. 26, 2002

(30) Foreign Application Priority Data
Sep. 27, 2001 (AU) PR7968

(51) Int. Cl. G06F 7/00

(52) U.S. Cl. 707/3

(57) ABSTRACT

A database query interface tool for querying a database is disclosed. A search query input section receives a database query from a user. A display section displays a list of items from the database that satisfy the database query and allows a user to select one of the items in the list of items. A display section displays metadata about the selected item and allows selection/deselection of one or more metadatum from the metadata. A display section displays a list of related items in the database that are related to the selected item in accordance with the selected or deselected metadata.

### RELATED APPLICATION

This application expressly incorporates by reference the full specification of an application titled “Database Query System and Method”, Ser. No. 08/___,___ filed on even date herewith.

### FIELD OF THE INVENTION

The present invention is directed to user interface for navigation of information, and more particularly, to user interface relating to and for searching a directed graph data structure database.

### COPYRIGHT NOTICE

A portion of the disclosure of this patent document contains material which is subject to copyright protection. The copyright owner has no objection to the facsimile reproduction by anyone of the patent document or patent diclosure as it appears in the Patent and Trademark Office patent file or records, but otherwise reserves all copyright rights whatsoever.

### BACKGROUND OF THE INVENTION

Many large electronic databases of documents and other items exist. It is difficult for a user to easily search these databases to find the information needed. In particular, a user may find a document in a database, and wish to review other similar documents. Often, to do this, the user is required to enter another search query or a refining search query, using the query language of the database. If the user is unable to devise good search terms, the user may be presented with a large number of irrelevant documents, or a small number of documents and miss out on relevant documents.

Many search techniques exist that allow users to search databases. These techniques include Boolean keyword searches and hierarchical searches. It is difficult for a user to devise a keyword search that turns up only those documents that are relevant to the user. Hierarchical searches are time-consuming for large databases of different information.

There is a need for a search system and database structure that allows a user to find related documents or narrow down search results without having to enter new queries, but where the narrowing is based on criteria selected by the user from possible relevant criteria selected by the computer.

U.S. Pat. No. 6,275,821 to Danish describes a system for executing a guided parametric search. The Danish system requires that the data to be searched is stored in data files, and that each data file identify one alternative for each item. Thus, the Danish database is highly structured, and significant work is needed if implemented in a large database to identify alternatives for each item. In effect, the alternatives are hard-coded in the database. Also, the Internet implementation of the Danish system does not perform local (client) processing. Moreover, the user interface is highly specific to the application (for example, a window for each parameter), and is not easily transferable to other applications.

Many search techniques exist that are specific to a structured, relational database. However, these search techniques are not appropriate for non-relational databases.

U.S. Pat. No. 6,236,987 to Horowitz is directed to dynamic content organization in an information retrieval system. This system requires documents to be stored in a datastore and that each document be bound to at least one topic.

U.S. Pat. No. 6,094,652 to Faisal describes a hierarchical query feedback method. This requires nodes of terminology to be arranged hierarchically.

U.S. Pat. No. 6,275,229 to Weiner describes a method for analyzing information on a computer, where the information is organized based on attributes and displayed in a graphical form. The primary focus of this patent is assigning screen icons to each information record and displaying the results of searches graphically. It does not, however, assist a user refine search results.

Thus, there is a need for a system that easily allows a user to easily refine database searches and that does not require significant engineering to establish the appropriate database to do this.

### SUMMARY OF THE PRESENT INVENTION

The present invention is directed to a user interface display for the navigation of information stored in a directed graph structure. More particularly, the present invention is a system and method for searching a directed graph data structure by the selection and deselection of individual nodes in the structure which has the effect of recursively refining information displayed to the user or directing the user to a new search area.

The present invention interacts with a database. The term “database” is used here in its most general sense, which may or may not refer to a relational database. In a representative embodiment, the data is stored in the form of a triples composed of subject-predicate-object statements. Each statement represents a relationship between nodes in a directed graph data structure. An element will represent either a subject (possibly a Uniform Resource Locator or Indentifier, URL or URI), predicate or a literal (plain text). According to the present invention, this is called a knowledge store. The data to be searched can be, for example, documents comprising text or metadata regarding those documents or both.

Metadata is data about data. For example, the title, subject, author, and size of a file constitute metadata about the file, as would concepts discussed within a file. Metadata should be distinguished from a keyword. A keyword is a word that appears in a document. Metadata for a document, if it is a word, need not be a word in the document.

A user wishes to search a database of documents and/or metadata to find relevant documents. The user formulates a query, and submits that query via the user interface of the present invention.

In the representative embodiment, a query engine processes the query and returns a list of nodes in the directed graph (sometimes called a list of hits) that satisfy the query. These nodes may represent documents (resource nodes) or metadata (literal nodes).

Using the user interface of the present invention, the user is able to narrow the list of hits by selectively choosing from the list of metadata.

Thus, the present invention provides an efficient and user friendly way to narrow search results without using a query language.

The following is a summary of one example of use of the present invention. The user wishes to query a database of metadata about newspaper articles for stories about venture capital. The newspaper articles themselves may be stored in the same database or in another location altogether. At the user interface, the user enters the search term “venture capital.” A list of newspaper articles is returned from the search engine, along with metadata about those articles. The user selects one article from the list of articles, and that article is displayed in a section of the user interface. In a second section of the user interface, metadata about the displayed article is presented to the user. For example, that metadata about the article may include the following grouped legal terms: “corporations”, “shareholders”, “fund raising”, “directors”, “mergers” and “intellectual property”. In a third section of the user interface, a list of related resources can be displayed. The related resources may be a specified number of other newspaper articles most similar to the selected article, according to the application of one or more algorithms. The related resources are ranked, according to the application of one or more algorithms, according to similarity to the selected article. The related resources may be ordered or starred to show to the user how similar these articles are to the selected article. The user can select and deselect metadata from the second section to refine and/or reorder the list in the related resources section. Thus, as the user selects and deselects each item of metadata in the second section, the related resources list displayed in the third section is dynamically and automatically changed so that the third section displays a list of those articles that are most related to the selected article in accordance with the selected metadata groupings.. For example, if the user only selects the metadatum “intellectual property”, then only those newspaper articles from the related resources list that are about intellectual property are listed in the third section. The user can select an article listed in the third section, in which case that article will be displayed in the first section and the process continues again. Alternatively, the user can select/deselect metadata groupings in the second section, in which case the related resources list in the third section is dynamically changed in real-time in accordance with such selections.

Optionally, each metadata node can also display the number of occurrences that this node appears in the database. By selecting this number attached to the node the application will display all documents that reference that node in the second section. This is an inverted display of the metadata. The user can now deselect/select documents which will result in the third section showing related ranked nodes which are similar across the selected/deselected documents. For example, selecting “intellectual property” would show a list documents that reference this legal term. By selecting/deselecting documents the third section may display nodes in rank order like “non-exclusive”, “perpetual”, and “royalty-free”.

If a user chooses to view a literal node (i.e. not a resource node) which does not represent an article, metadata and related resources for that node are still displayed but no article will be shown in the third section.

Thus, the present invention allows users to easily refine searches by refining a list of related resources. The user can select the types of information that the user believes is related and not related, from types (metadata) determined and presented by the present invention.

In summary, according to the representative embodiment, the user interface of the present invention comprises five sections: a section to input a search query; a section to display a list of search results and to allow a user to select one of the search results; a section to display the contents of a selected item; a section to display metadata about the selected item and to allow the user to select/deselect such metadata; and a section to display related resources and to allow a user to select one of the related resources. These sections can be displayed on a single screen at the same time or can be displayed at different times as needed. The sections can be combined as required, for example, the section to display the list of search results and the section to display the list of related resources can be the same section. The different sections can be displayed in different windows or in different parts of the same window.

The present invention has many applications. For example, it could be used by trial attorneys as a support tool to search and review a database of electronic mail messages as part of preparation for litigation. The present invention can assist attorneys to easily find linkages and associations between emails.

The present invention could be used as an interface to a database of patent documents. A patent searcher would be presented with a list of patents that satisfy a query. The patent search would select one patent document, and an ordered list of related patents would be displayed, as well as metadata about that selected patent. The metadata could be the name of the inventor, the name of the assignee, the U.S. classes, the priority date, etc., as well as metadata about the contents of the text of the patent (such as “software”, “menu”, “database”, and so on) Using the present invention, a patent searcher could easily find the patents most related to a particular patent, in accordance with criteria dynamically selected by the patent searcher. Thus, the patent searcher could narrow search results quickly without having to re-enter queries and without use of a query language.

The present invention can be used in many other applications, including to search documents or Web sites on the World Wide Web and to search extremely large databases of documents. The documents that are searched need not be of the same type. For example, one application of the present invention can search electronic mail messages, email attachments, word processing documents, Web pages and information in structured relational databases.

According to the representative embodiment of the present invention, the database is implemented as a secure, typeless, distributed database of statements. In the representative embodiment, the database that is searched using the interface of the present invention is not a relational database, but rather, a triple store. It is possible to use the present invention with a relational database, although some significant loss of search efficiency would occur.

Many other features and embodiments of the present invention are described in detail below.

### BRIEF DESCRIPTION OF THE DRAWINGS

FIG. 1 is a block diagram showing typical hardware elements that operate in conjunction with the present invention.

FIG. 2 is a block diagram showing, at a high level, the software components utilized in conjunction with a representative embodiment of the present invention.

FIG. 3 is an exemplary interface display illustrating an initial search state for a representative implementation (called Implementation A herein) of the user interface of the present invention.

FIG. 3A is a populated example of FIG. 3.

FIG. 4 is an exemplary interface display illustrating the results of a simple term search in representative Implementation A, viewed by the number of messages received by each recipient.

FIG. 4A is a populated example of FIG. 4.

FIG. 5 is an exemplary interface display illustrating the results of a simple term search in representative Implementation A, viewed by the date of messages.

FIG. 5A is a populated example of FIG. 5.

FIG. 6 is an exemplary interface display illustrating a given message and its associated metadata in representative Implementation A.

FIG. 6A is a populated example of FIG. 6.

FIG. 7 is an exemplary interface display listing messages similar to the message mentioned in FIG. 4, based on selected metadata.

FIG. 7A is a populated example of FIG. 7.

FIG. 8 is an exemplary interface display showing resources related to a document, based on an inference calculation in representative Implementation B.

FIG. 8A is a populated example of FIG. 8.

FIGS. 9A, 9B and 9C illustrate how the knowledge store of FIG. 2 can be configured.

### DETAILED DESCRIPTION

The present invention comprises a computer user interface 20 which can be implemented in a variety of manners. Two representative implementations are discussed below, both of which are two-dimensional screen paradigm user interfaces 20 implemented in a World Wide Web browser. This invention is not limited to either the two-dimensional screen style or a World Wide Web browser implementation. This invention could be used with a dedicated desktop application, a mobile device user interface or another user interface model.

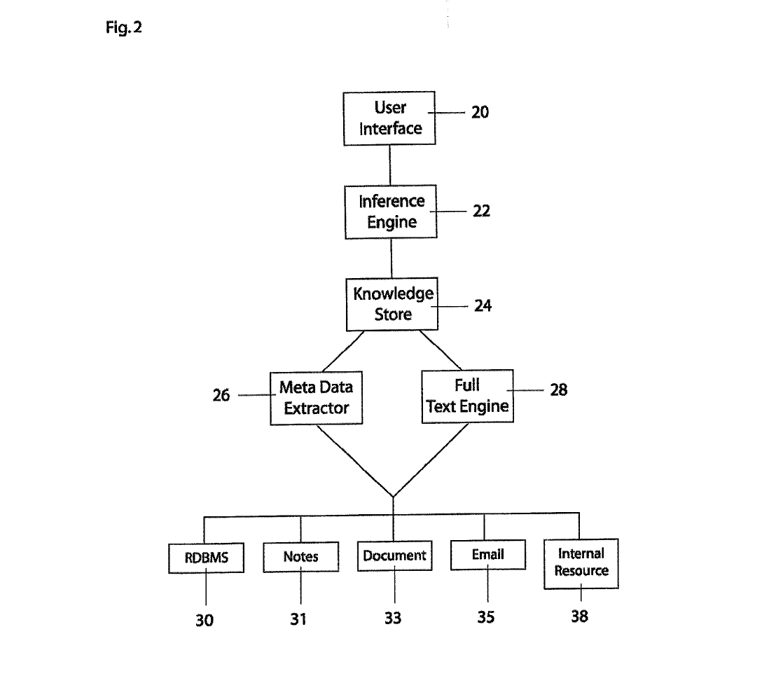

Representative implementation A is a search tool for discovering relationships between electronic mail messages in a message store 35. Metadata representing message headers, concepts, key words and full text indices are placed in a directed graph data structure. The directed graph structure is one component of the knowledge store, 24, shown in FIG. 2. These metadata are used to represent each message in a store 35. A directed graph (non-relational and non-hierarchical) database is used to store the metadata and make it available for query via a query language. This representative embodiment of the present invention provides a user interface 20 to allow searching of the metadata in order to determine relationships that exist between metadata sets representing various messages in the store 35.

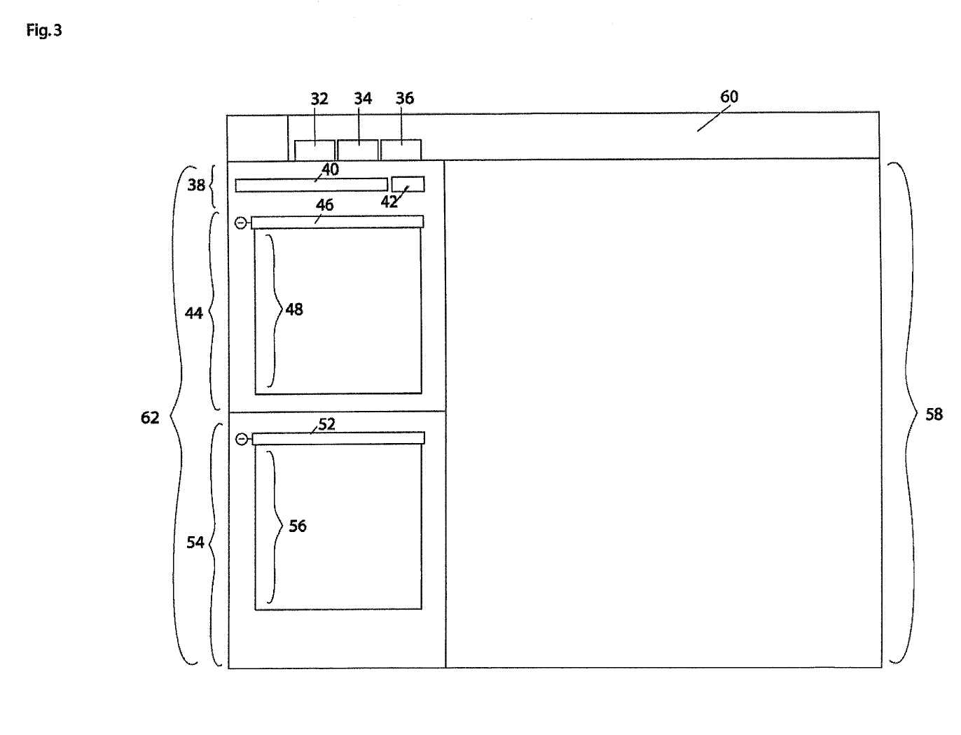

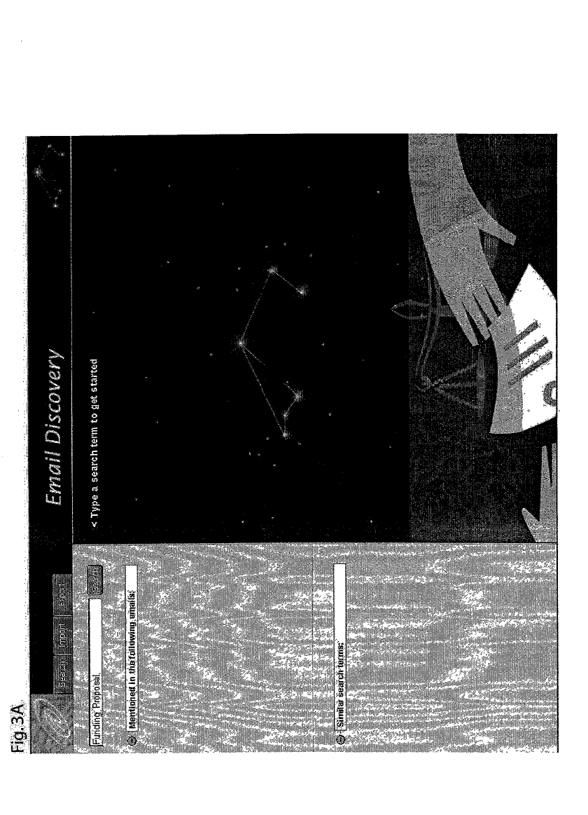

Parts of representative implementation A's interface are shown in FIGS. 3 to 7, as discussed in detail below. Representative implementation B is an application that holds metadata related to more general documents in a document store. In this implementation, either metadata nodes or document nodes in the directed graph may be displayed. If a document node is displayed, the original document is shown along with its associated metadata and a list of links to related documents. The list of related documents is calculated based on the selection of associated metadata.

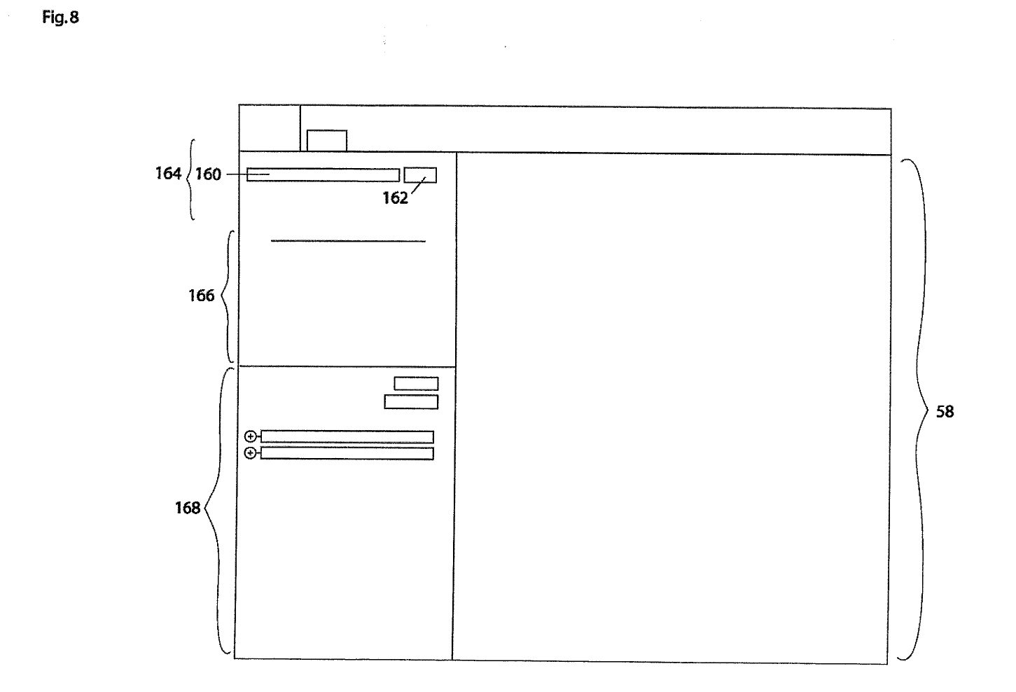

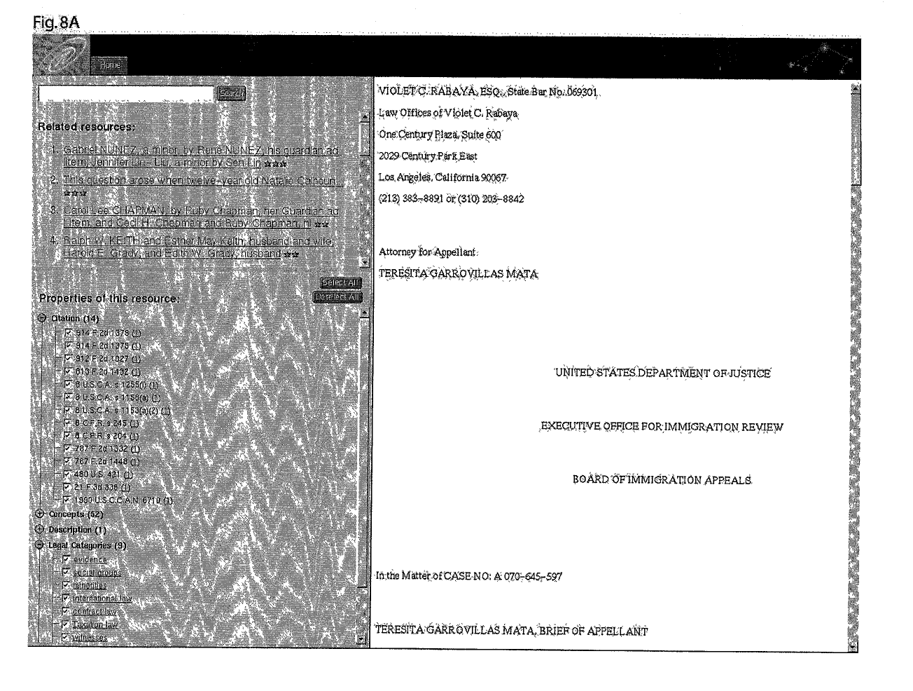

Parts of representative implementation B's interface are shown in FIG. 8, as discussed in detail below.

The user interface 20 of the representative embodiments of the present invention is implemented in conjunction with a database to enable specification of document retrieval similarity using multiple dimensions (e.g., date, type of document, concepts, names). This promotes the rapid discovery of highly relevant information.

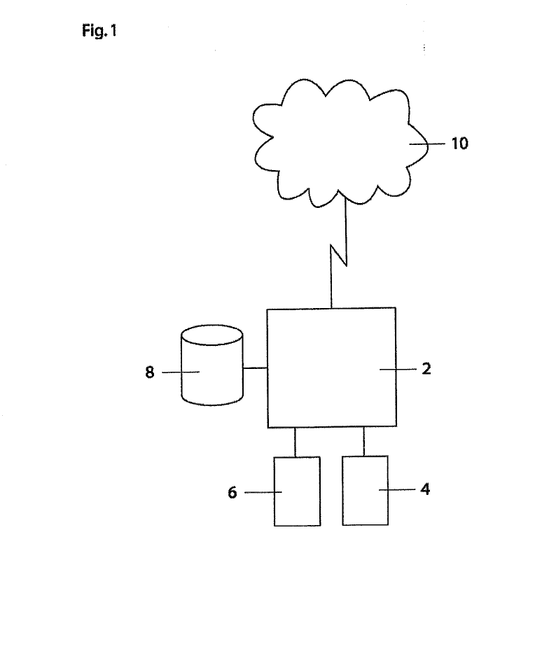

Referring now to the drawings, and initially FIG. 1, there is illustrated in block diagram form representative hardware elements used to process a representative embodiment of the present invention. An overview of an appropriate hardware configuration is described. Using this configuration, the representative embodiment of the invention can be employed.

A computer processor 2 is coupled to an output device 4, such as a computer monitor. The computer monitor can display the user interface 20 of the present invention. The computer processor is also coupled to one or more input devices 6, such a keyboard, a mouse and/or a microphone. A user uses the input device 6 to provide input (such as queries and selections) to the computer process 2. The computer processor 2 is also coupled to one or more local electronic storage devices 8, such as a RAM, ROM, hard disk and/or a read-write DVD drive. If desirable, the local storage devices 8 can store part or all of the program logic of the present invention and/or the database of the present invention. The program logic of the present invention can be executed by the computer processor 2.

The computer processor may also be coupled to one or more computer networks 10. The computer network 10 may be a LAN, WAN, extranet, intranet or the Internet. If desirable, some or all of the program logic and/or the database of the present invention can be stored remotely on the computer network 10 and accessed by the computer processor 2.

In the representative embodiment, computer processor 2 operates a browser program, such as Netscape Navigator, which is displayed to a user on the output device 4.

Due to the nature of the software of the present invention, the exact specification of the underlying hardware is not vital for the purposes of the invention.

The computer processor 2 most commonly is part of a personal computer. However, the present invention is implemented to take advantage of new hardware platforms (such as handheld devices) as they become available.

In the representative embodiment, the computer processor 2 can be used by a typical user to access the Internet and view web pages or other content, and run other application programs. Although the processor 2 can be any computer processing device, the representative embodiment of the present invention will be described herein assuming that the processor 2 is an Intel Pentium processor or higher. The storage device 8 stores an operating system, such as the Linux operating system, which is executed by the processor 2. The present invention is not limited to the Linux operating system, and with suitable adaptation, can be used with other operating systems. The representative embodiment as described herein was implemented in the Java programming language which allows execution on multiple operating systems.

Application program computer code of the present invention can be stored on a disk that can be read and executed by the processor 2.

FIG. 2 illustrates in block diagram form typical components that interact with the present invention. The user interface 20 is coupled to an inference engine 22 (sometimes called a query/inference engine). The inference engine 22 enables disparate information sources to be collated, compared and queried based on a set of rules and facts, and inferences made on those rules and facts. For instance, a typical search engine could find a resource with a textual-string “seal”—which may be an engine part or a mammal. An inference engine can determine the difference between these two “classes” of “seal”. In the representative embodiment, the inference engine 22 has been implemented in the Java programming language. It uses algorithms for inferring relationships from a directed graph data store. The process of inferencing is implicit and takes place following each query to assist in refining query results. Examples of algorithms used for inferencing are the forward- or backward-chaining algorithms commonly used in expert systems.

It is possible to implement the present invention without the inference engine 22.

The inference engine 22 is coupled to a knowledge store 24. In the representative embodiment, the knowledge store 24 is a specialized database capable of searching more than fifty thousand metadata statements per second. This is based on a data structure that is tuned to enable specialized graph queries and updates. This is not based on relational database software due to the inefficiencies in query language and network performance overheads. Relational databases have severe limitations on their ability to perform distributed queries.

The knowledge store 24 is optionally coupled to a metadata extractor 26 or a full text engine 28 or both.

The metadata extractor 26 of the representative embodiment of the present invention combines metadata extraction tools and resolves their output into one consistent form. It can extract metadata from a variety of data sources (e.g., 30 to 38) such as files systems, email stores and legacy databases. During the extraction process individual tools perform specific tasks to discovery metadata. For example, extracting names, places, concept, dates, etc. The combination of the output of these tools produces a single metadata file that is then sent to the knowledge store 24 for persistence. Individual metadata extraction tools may be plugged into a common metadata extraction framework. Thus, these tools may be manufactured and maintained by separate organizations. The representative embodiment uses metadata extraction tools that can be licensed from commercial suppliers, such as Management Information Technologies, Inc of Gainesville, Fla., which makes the Readware concept extraction tool or Intology Pty. Ltd. of Canberra, Australia, which makes the Klarity metadata extraction tool. The representative embodiment can also uses proprietary and public domain metadata extraction tools.

The full text engine 28 of the representative embodiment of the present invention indexes original content such as 30, 31, 33, 35 and 38. Full text indexes are treated as another form of metadata, allowing the query text entry box 40 to be used simultaneously for metadata and full text searches.

The metadata extractor 26 and the full text engine 28 both access data in data stores. (Alternatively, if a metadata extractor 26 or full text engine 28 are not required, the knowledge store 24 can access data in the data stores, or can incorporate the data directly in the knowledge store 24.) This data can be large volumes of constantly changing, unstructured information of different types. For example, this data can be data in a relational database 30, data in a Lotus Notes database 31 and legacy database, documents 33 stored in a file systems and memory device, such as word processing documents, RTF documents, PDF documents, and HTML documents. This data can also be email messages in email stores 35 and Internet resources (URLs) 38.

The user interface 20, inference engine 22, knowledge store 24, metadata extractor 26 and full text engine 28 can all be controlled and execute upon a single processor (e.g., 2 of FIG. 1).

FIG. 3 shows an initial state of representative implementation A, at which point a user is expected to enter a search term. FIG. 3 is an outline of the user interface 20 which is presented to a user on an output device 4.

As stated above, representative implementation A is a search tool for discovering relationships between electronic mail messages in a message store 35. This representative embodiment of the present invention provides a user interface 20 to allow searching of the metadata in order to determine relationships that exist between metadata sets representing various email messages in the store 35.

Representative implementation A is particularly useful as an email discovery tool for use by a litigator who is required or desires to review a large number of email messages. Representative implementation A can mine email boxes in any format (e.g., Microsoft Exchange, Lotus Notes, Groupwise, mbox, etc.). It can classify emails referring to key issues input or selected by the user. Optionally, representative implementation A can be interface with an electronic legal thesaurus to provide intelligent concept searching. Representative implementation A can present information in a way to allow the user to follow issues within discussion threads. It can build chronologies of email activity and graphs to show intensity of traffic between individuals over a period of time related to specific topics.

In summary, as explained in detail below, a user enters search criteria and identifying information for those emails in the store 35 that satisfy the criteria are displayed in the user interface 20. Terms similar to the search term can also be displayed along with the number of emails that satisfy those terms. Once an email message is selected by the user, properties of that email are displayed, such as date, to, cc, from, subject, concept, legal issues, attachments, size and named people and places. These properties are automatically captured and displayed to the user in the user interface 20 to support further searching. The user can select or deselect these properties, and other similar emails are determined by reference to the selected properties.

In FIG. 3, there are three action groupings in this application. Action group one gives the ability to search a directed graph of message metadata and is accessed via tab 32. This is the default action group. Action group two provides the ability to import metadata from message stores into the application and is accessed via tab 34. Action group three allows a user to export metadata into other commonly-used formats and is accessed via tab 36. The representative embodiment of the present invention is directed to the user interface of action group one. Action group tabs reside in menu area 60.

A search area 38, includes a text entry field 40 and a search button 42. Users enter one of several types of search terms into the text entry field then initiate the search by selecting the search button. Search terms may be exact or partial matches to metadata literals, full text index terms, and uniform resource locator (URL) pointers to original document locations.

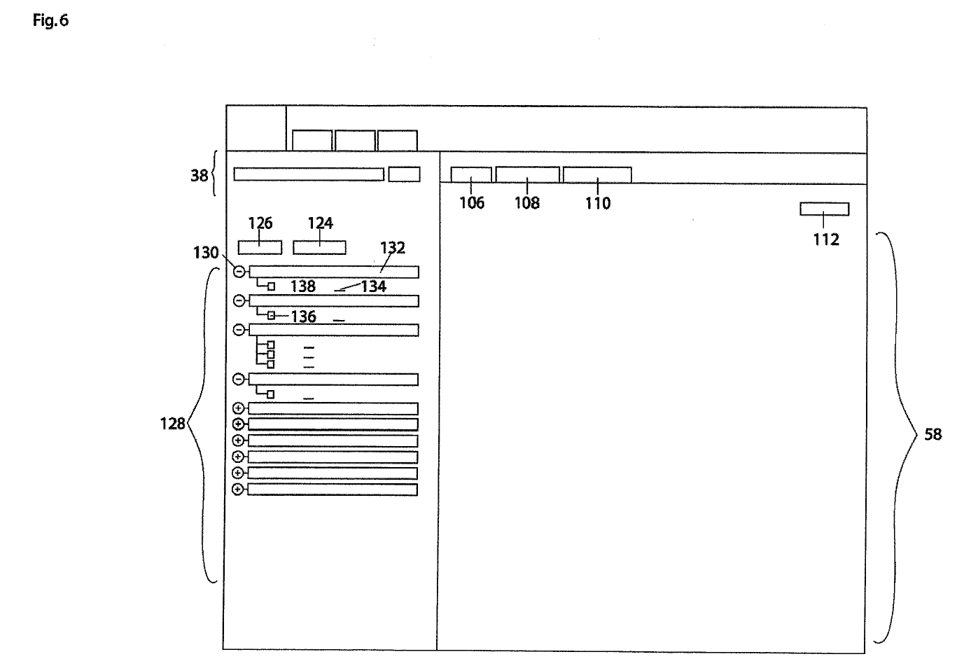

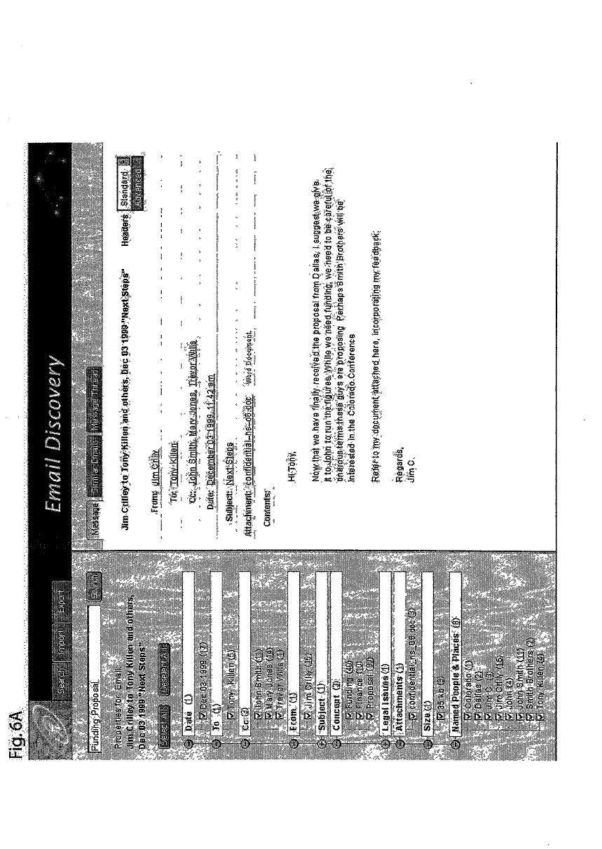

The metadata display area 62 is segmented in metadata node views into two smaller areas; the references area 44 and the similar terms area 54. The metadata node view is used to show a group of metadata associated with a particular metadatum. This contrasts with the resource node view which is used to show all metadata relating to a particular resource (such as a document) The resource node view is described below and illustrated in 128 on FIG. 6.

The references area 44 includes formatted header information 46 and an area in which to list hyperlinks to messages which match current search criteria 48.

The similar terms area 54 includes formatted header information 52 and an area in which to list terms similar to the current search term 56.

The main display area 58 is an area for the display of messages, calculation results and search refinement hints.

FIG. 3A shows a populated implementation of FIG. 3.

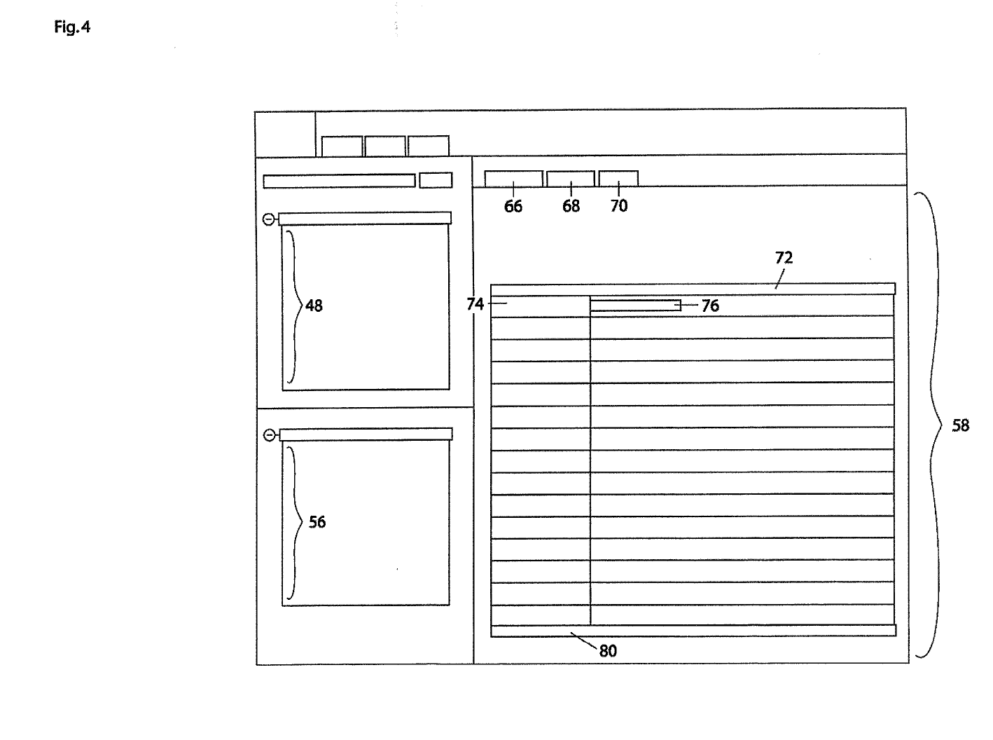

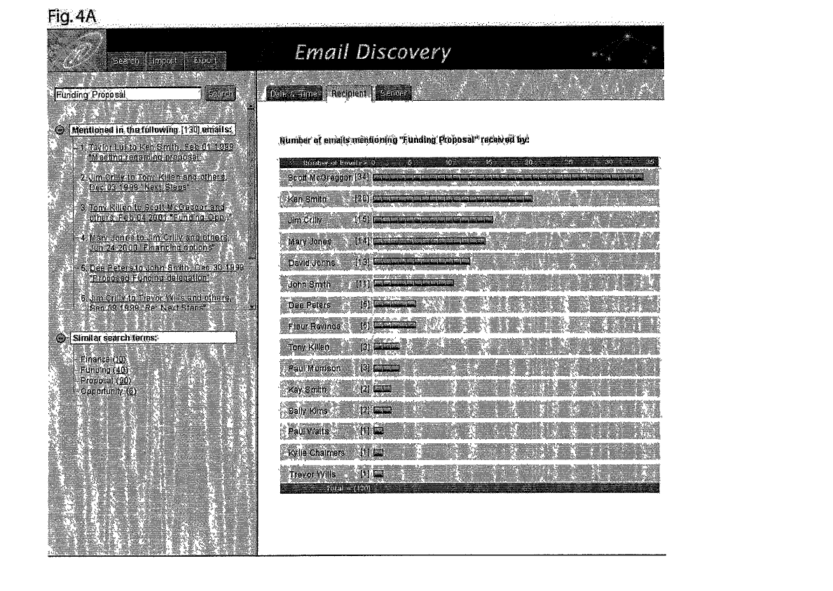

FIG. 4 shows the results of a term search. The interface is still displaying information about a metadata node. 48 and 56 will now be displaying information relating to the search.

The main display area 58 is now filled with a tabbed panel which displays various views of metadata information regarding the search state. Three tabs are used in the representative implementation; Date & Time 66, Recipient 68 and Sender 70. FIG. 4 shows an example display when the Recipient tab 68 is selected. The Recipient tab 68 is the default tab selected.

The Recipient tab 68 in the panel shows a graph representing the number of messages relating the search term received by individual electronic mail accounts, sorted by number received. The Sender tab 70 operates in the same fashion for messages sent and is not illustrated.

The count of messages graphed is shown in a header 72. Each user is represented by proper name (or electronic mail address or account name if a proper name is not available) 74. The number of messages received is shown graphically 76 and the number mirrored in a standard tooltip. The total of messages matching the search criteria is also shown in a label 80.

FIG. 4A shows a populated implementation of FIG. 4.

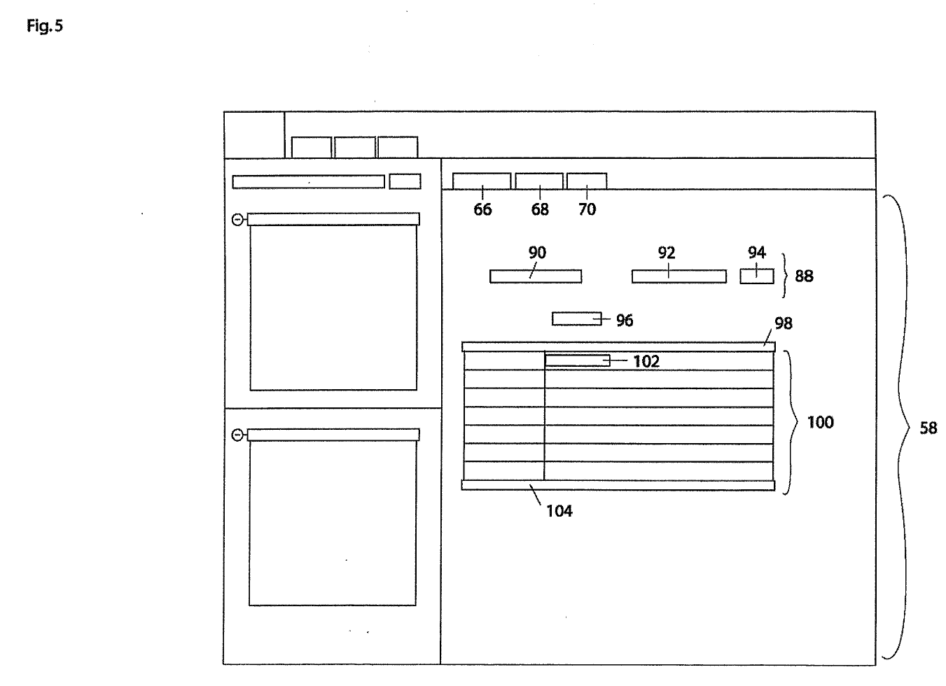

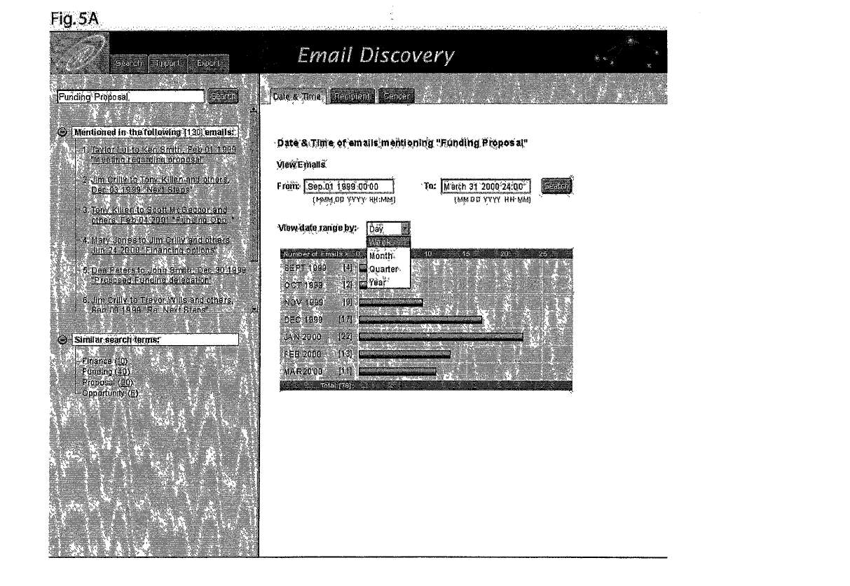

Turning now to FIG. 5, the Date & Time tab 66 displays a graph 100 of the matching messages over time. The number of messages per time is shown in header 98 and the total number of messages is shown in label 104. The number of messages in each time period is shown by a bar 102 with the number mirrored in a standard tooltip.

The date range may be displayed in different time units (e.g. week, month, quarter, year) by selecting the desired time unit in select or choice box 96.

The search may be refining by specifying a date range using the date range selection group 88. This group includes two text areas 90 and 92 into which are entered date strings for the from and to dates, respectively. A calendar widget may also be used to enter these dates. Search button 94 is used to execute the new search once the dates have been entered.

FIG. 5A shows a populated implementation of FIG. 5.

FIG. 6 shows a resource node view. A tabbed panel in 58 now includes tabs to display a selected message 106, similar messages to the selected one 108 and information about the message thread 110.

FIG. 6 specifically shows a message listing in 58 with the message tab selected. Message header contents are hyperlinked to facilitate either narrowing a search or searching in a new direction (not shown). A button 112 is provided to toggle the view between an abbreviated representation of the message (e.g. to show only commonly used headers) or the entire message contents.

The contents of metadata display area 62 change when in resource node view to show a summary of metadata information for the selected resource 128. Not all metadata may be displayed in this list; metadata about metadata, for example, may be explicitly ignored in the user interface 20.

Metadata for the selected resource is shown in 128 and is subdivided by headers (e.g. 132). The display of metadata under each header may be toggled on or off using a hierarchical menu control 130. Each metadatum is displayed with three elements: a checkbox 136, a label 138 representing the metadatum and an optional trailing hyperlink 134. The checkbox is used to refine or modify a search by adding or removing the particular metadatum from the search query. The optional trailing hyperlink is used to provide appropriate shortcuts to refining or modifying the search query based on the metadatum. For example, a representative metadatum might be the concept of “funding”. This could occur under a heading of “Concepts”. Selecting the checkbox would result in “funding” being included in the search query for related metadata for the current resource. The label could be the literal metadata string “funding” or another string selected to represent it. The optional trailing hyperlink could be a shortcut to a search for all resources that relate to the current resource via the metadatum “funding”.

Convenience buttons for selecting all (126) or none (124) of the displayed metadata are provided.

FIG. 6A shows a populated implementation of FIG. 6.

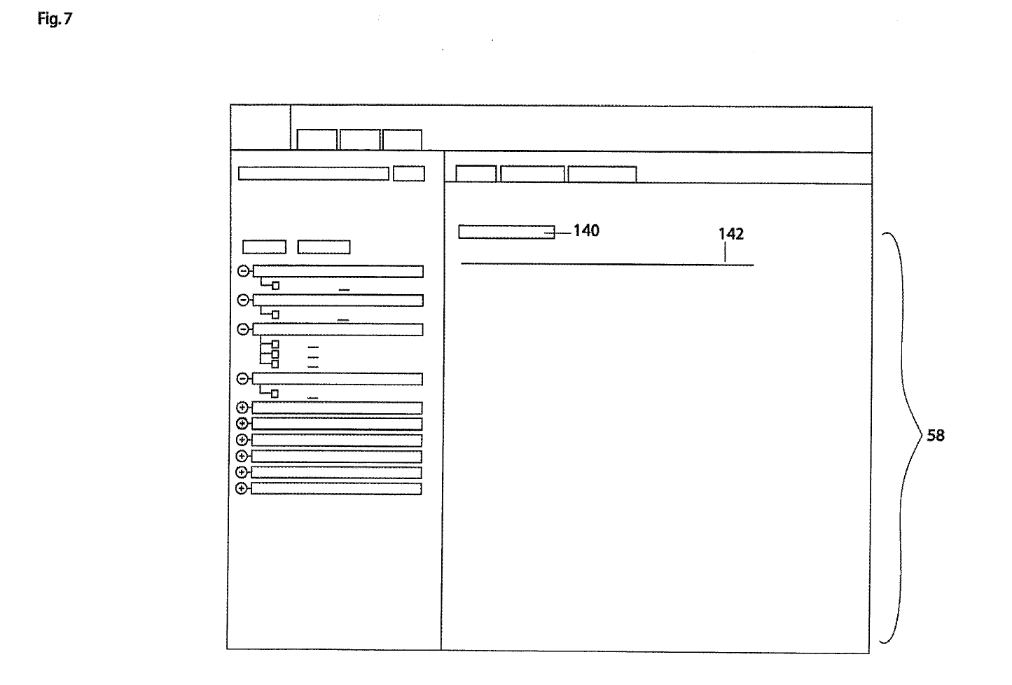

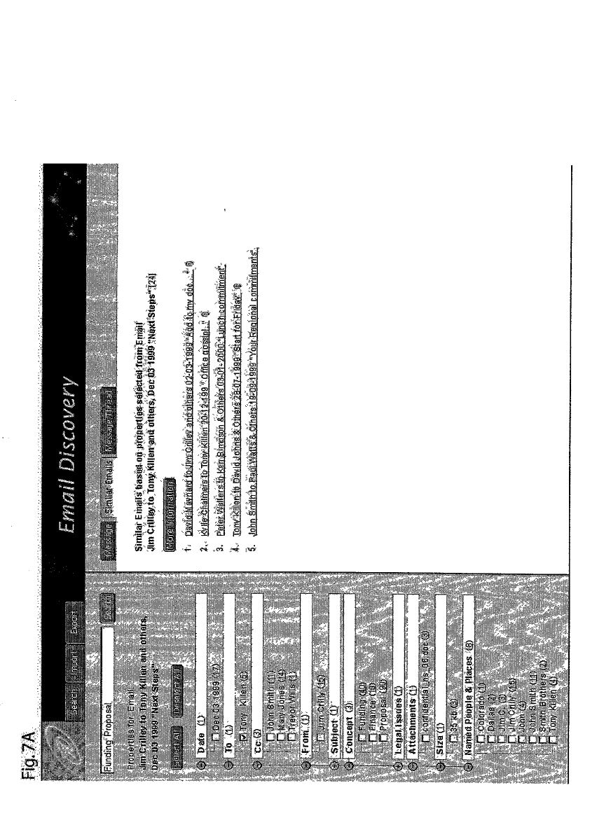

FIG. 7 shows the results of selecting the similar messages tab 108. A list of message descriptions pointing to similar messages to the current one (based on selected metadata) is displayed in 58. Each message description 142 may include other helpful information such as a hyperlink, a reference number, an indication of whether the message has attachments and a relevancy ranking. A button 140 toggles the details of the message summaries between the simple state described above and a more detailed state which makes use of other metadata about the messages.

The information displayed in the similar messages panel may be effected by the state of the metadata checkboxes 136. As checkbox selections are changed, the information displayed in the similar messages panel changes to represent the results of the updated search.

FIG. 7A shows a populated implementation of FIG. 7.

FIG. 8 shows user interface components for representative implementation B.

As discussed above, representative implementation B is an application that holds metadata related to more general documents in a document store. If a document node is displayed, the original document is shown along with its associated metadata and a list of links to related documents. The list of related documents is calculated based on the selection of associated metadata.

Representative implementation B can be used, for example, to search a wide variety of documents and for many different applications. For example, it can be used to search published patent databases, databases of court decisions and statutes, databases of publications and newspaper articles, collections of Web pages and/or Web sites, and files on file servers of a large corporation or government department.

In FIG. 8, the search area 164 is the same as the search area 38 of representative implementation A. It includes a text entry field 160 and a search button 162. Users enter one of several types of search terms into the text entry field then initiate the search by selecting the search button. Search terms may be exact or partial matches to metadata literals, full text index terms, uniform resource locator (URL) pointers to original document locations.

Area 58 is used for display of a document (or left blank if no document is selected). Metadata held in the system for the selected document is displayed in area 168, which is functionally the same as area 128 with buttons 124 and 126 from representative implementation A. A list of hyperlinks to resources related to the selected resource are shown in area 166, which is functionally similar to hyperlinks 142 of representative implementation A. Related resources are again based on the currently selected metadata in area 168.

If the interface is displaying a metadata node instead of a document (resource node), area 168 will still be used to show related metadata but area 166 will not show related resources. Area 58 will be blank or used for another purpose.

FIG. 8A shows a populated implementation of FIG. 8.

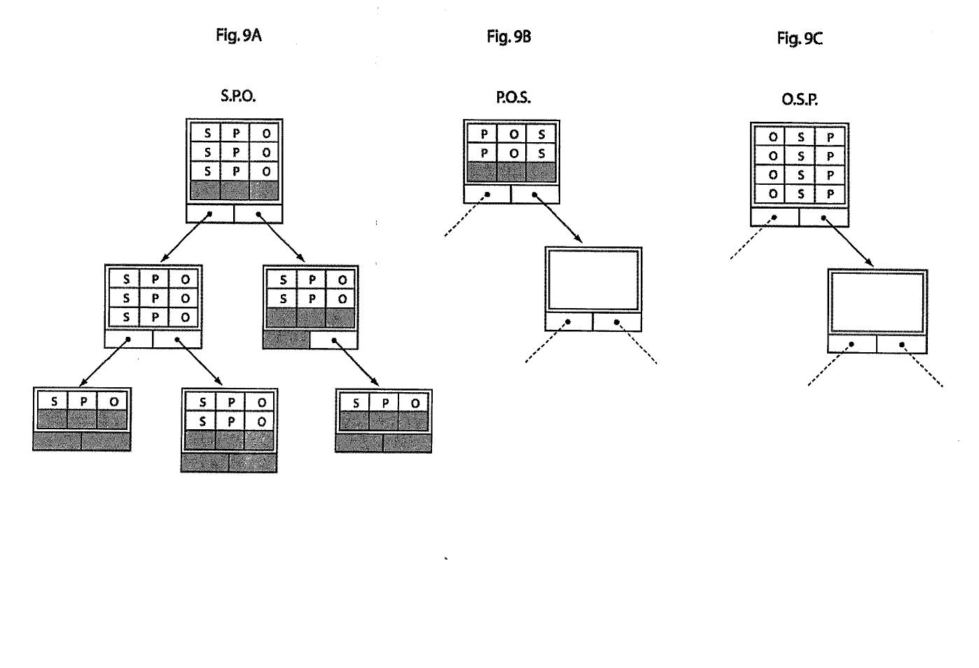

FIGS. 9A, 9B and 9C illustrate how the knowledge store 24 is configured.

The knowledge store 24 stores statements (short fixed sentences), which comprise a subject, a predicate and an object. In the representative embodiment, these statements are indexed with three parallel AVL trees (a well-known indexing method) on top of Java 1.4's new memory mapped I/O mechanism. AVL is a structure that is named for its inventors, Adelson-Velskii and Landis.

The statements in the knowledge store 24 could, for example, be Resource Description Framework (RDF) statements.

Subjects and predicates are resources. Resources may be anonymous or they may be identified by a URL. Objects are either resources or literals. A literal is a string (i.e., text).

Subjects, predicates and objects are represented in a directed graph (Graph) as positive integers called graph nodes. The node pool keeps track of which graph nodes are currently in use in the Graph so that they may be reused. The string pool is used to map literal graph nodes to and from their corresponding string values. The three graph nodes that represents a statement are collectively referred to as a triple.

FIGS. 9A, 9B and 9C illustrate the internal workings of the directed graph implementation in the knowledge store 24.

Each of these three figures shows a portion of an index of a directed graph data structure implemented in a AVL tree. FIG. 9A shows the data (stored as a series of triples) sorted by the first component of the triple. In the representative embodiment, the first component of each triple represents a subject. FIG. 9B shows the same data set, this time sorted by the second component which is a predicate in the representative embodiment. FIG. 9C shows the same data set, this time sorted by the third component which represents an object in the representative embodiment. Thus it is a feature of the knowledge store's 24 directed graph data structure that the implementation consists of three indices (one for each component of a triple). The data is stored only in the indices and is not stored separately elsewhere. Storing the data three times increases the storage requirements for the data set but allows for very rapid responses to queries since each query component can use the most appropriate index.

In the representative embodiment, the Graph stores triples in three AVL tree indices. Each triple is stored in all three AVL trees, as shown in FIGS. 9A, 9B and 9C. The AVL trees each have a different key ordering, defined as follows:

(subject, predicate, object),

(predicate, object, subject) and

(object, subject, predicate).

Each node in an AVL tree comprises:

a set of triples sorted according to the key order for this tree.

the number of triples in the set for this node.

a copy of the first triple in the sorted set.

a copy of the last triple in the sorted set.

the ID of the left subtree node.

the ID of the right subtree node.

the height of the subtree rooted at this node.

All triples in the left subtree compare less than the first triple in the sorted set and all triples in the right subtree compare greater than the last triple in the sorted set.

Space for a fixed maximum number of triples is reserved for each node.

A triple is added to a tree by inserting it into the sorted set of an existing node. If the only appropriate node is full then a new node will be allocated and added to the tree.

A triple is removed from the tree by identifying the node which contains it and removing it from the sorted set. If the sorted set becomes empty then the node is removed from the tree.

AVL tree nodes are split between two files such that the sorted set of triples for a node are stored as a block in one file while the remaining fields are stored as a record in the other file. This ensures that the traversal of an AVL tree does not result in sorted sets of triples being unnecessarily read into memory. This also allows for different file I/O mechanisms to be used for the two files.

The storage structure and architecture of the representative embodiment of the present invention better reflects the unstructured complexity of the real world. It yields faster, more efficient searching. The inference framework automatically extracts, collates and relates unstructured and structured data stores from multiple locations.

The implementations described above do not need to construct an index from the documents using the identifiers in the search result. This simplifies processing.

The present invention can successfully operate without the need for a relational database structure or a hierarchical database of records. (As discussed above, the nodes of the representative embodiment are not arranged hierarchically.)

Unlike some existing system, the present invention does not evaluate returned query results to identify common characteristics. Instead, connections are noted between the current node (or node representing a document) and surrounding nodes. Any connections present in the underlying directed graph data structure are noted and displayed. This allows a different (and arguably better) set of inferencing algorithms to be applied to the data. The present invention does not need to identify query themes associated with a search query, and it does not need to use frequency terms or a history of search queries in the present invention's query methods.

As can be seen from the description above, the representative embodiments of the present invention does not analyze documents directly, but focuses on the metadata. The metadata may include some or all of the document itself, as well as full text indices of the document. Nevertheless, inferencing is performed by analyzing relationships between nodes in a directed graph and not by directly performing linguistic or lexical analysis on a source document. Analysis of a source document by those or other means may take place during metadata extraction.

Unlike prior systems that require documents to be stored in a datastore and that each document be bound to at least one topic, the representative embodiment of the present invention requires no such restriction. Documents may or may not be held in database backing this user interface described here and, if documents are held, they need not be bound to topics.

The representative embodiment of the present invention provides a user interface which represents data held in a directed graph data structure, in which data is arbitrarily connected. Data in a directed graph data structure is specifically not hierarchical.

The present invention has been described above in the context of a number of specified embodiments and implemented using certain algorithms and architectures. However, the present invention is of general applicability and is not limited to this application. While the present invention has been particularly shown and described with reference to representative embodiments, it will be understood by those skilled in the art that various changes in form and details may be made without departing from the spirit and scope of the invention.

What is claimed is:

1. A method for searching an electronic database comprising the steps of:
accepting a query from a user via a user interface;
providing, at the user interface, a list of items in the database that satisfy the query;
enabling the user, at the user interface, to select an item from the list of items;
providing, at the user interface, metadata about the selected item;
enabling the user, at the user interface, to select one or more metadata from the list of metadata; and
in response thereto, providing, at the user interface, a list of related items in the database that are related to the selected item in accordance with the selected metadata.

2. The method of claim 1 wherein the database comprises a database of documents.

3. The method of claim 1 wherein the database comprises a database of metadata.

4. The method of claim 1 wherein the database comprises a database of documents and of metadata.

5. The method of claim 1 wherein the database is not a relational database.

6. The method of claim 1 wherein the database comprises a representation of a directed graph structure.

7. The method of claim 6 wherein the step of providing, at the user interface, a list of items in the database that satisfy the query includes providing a list of nodes from the directed graph representation.

8. The method of claim 7 further comprising the step of:
providing, at the user interface, for each node in the list of nodes, the number of occurrences of that node in the database.

9. The method of claim 7 further comprising the step of:
enabling the user, at the user interface, to view a representation of each node in the database, showing metadata and related nodes for that node.

10. The method of claim 1 further comprising the steps of:
enabling the user, at the user interface, to deselect one or more metadata from the list of metadata; and
in response thereto, and in real time, providing, at the user interface, a revised list of related items in the database that are related to the selected item in accordance with the metadata provided but not deselected.

11. The method of claim 1 further comprising the step of:
ordering the list of related items in accordance with the selected metadata.

12. The method of claim 6 further comprising the step of:
ordering the list of related items in accordance with the selected metadata and the number of connections between the selected metadata nodes and the related items

13. A database query interface tool for querying a database, comprising:
a search query input section for receiving a database query;
a first display section to display a list of items from the database that satisfy the database query and to allow selection of one of the items in the list of items;
a second display section to display metadata about the selected item and to allow selection of one or more metadata from the list of metadata; and
a third display section to display a list of related items in the database that are related to the item selected in the first display section in accordance with the metadata selected in the second display section.

14. The database query interface tool of claim 11 further comprising a fourth display section to display the contents of the item selected in the first display section.

15. The database query interface tool of claim 11 wherein the database holds a representation of a directed graph structure.

16. The database query interface tool of claim 11 wherein the database holds a representation of a directed graph structure including resource nodes and literal nodes.

17. A database query tool for querying a database, comprising:
one or more data sources;
a metadata extractor coupled to the one or more data sources, wherein the metadata extractor extracts metadata from the data in the one or more data;
a knowledge store database, coupled to the metadata extractor, for receiving the metadata from the metadata extractor and for organizing the metadata as a directed graph structure; and
a user interface coupled to the knowledge store database comprising:
(a) a search query input section for receiving a database query,
(b) a first display section to display a list of items from the knowledge store database that satisfy the database query and to allow selection of one of the items in the list of items,
(c) a second display section to display metadata about the selected item and to allow selection of one or more metadatum from the metadata, and
(d) a third display section to display a list of related items in the knowledge store database that are related to the item selected in the first display section in accordance with the metadata selected in the second display section.

18. The database query tool of claim 15 wherein the user interface further includes a fourth display section to display the contents of the item selected in the first display section.

19. The database query tool of claim 15 further comprising a full text engine intercoupling the one or more data sources and the knowledge store database.

20. The database query tool of claim 15 wherein one of the data sources is an electronic mail store.

21. The database query tool of claim 15 wherein one of the data sources is a document store.

22. A method for searching an electronic database comprising the steps of:
accepting a query from a user via a user interface;
providing, at the user interface, an item in the database that satisfies the query;
providing, at the user interface, metadata about the selected item;
enabling the user, at the user interface, to select one or more metadata from the list of metadata; and
in response thereto, providing, at the user interface, a list of related items in the database that are related to the selected item in accordance with the selected metadata.

23. The method of claim 22 wherein the database comprises a representation of a directed graph structure.

24. The method of claim 23 wherein the step of providing, at the user interface, a list of items in the database that satisfy the query includes providing a list of nodes from the directed graph representation.

25. The method of claim 24 further comprising the step of:
enabling the user, at the user interface, to view a representation of each node in the database, showing metadata and related nodes for that node.

26. The method of claim 22 further comprising the steps of:
enabling the user, at the user interface, to deselect one or more metadata from the list of metadata; and
in response thereto, and in real time, providing, at the user interface, a revised list of related items in the database that are related to the selected item in accordance with the metadata provided but not deselected.

27. The method of claim 22 further comprising the step of:
ordering the list of related items in accordance with the selected metadata.

28. The method of claim 23 further comprising the step of ordering the list of related items in accordance with the selected metadata and the number of connections between the metadata nodes and the selected item.

29. A database query tool for querying a database, comprising:
a knowledge store database holding data in the form of statements that represent relationships between nodes in a directed graph data structure, the data including items and metadata; and
a user interface communicatively coupled to the knowledge store database comprising:
(a) a search query input section for receiving a database query,
(b) a first display section to display a list of items from the knowledge store database that satisfy the database query and to allow selection of one of the items in the list of items,
(c) a second display section to display metadata about the selected item and to allow selection of one or more metadatum from the metadata, and
(d) a third display section to display a list of related items in the knowledge store database that are related to the item selected in the first display section in accordance with the metadata selected in the second display section.
